(19) United States
(12) Patent Application Publication
(10) Pub. No.: US 2024/0148153 A1
(43) Pub. Date: May 9, 2024

(54) SUPPORT APPARATUS

(71) Applicant: Fairacre Support Ltd, Stanwell (GB)

(72) Inventor: Jonathan Cooper, Stanwell (GB)

(21) Appl. No.: 18/412,496

(22) Filed: Jan. 13, 2024

Related U.S. Application Data
(63) Continuation of application No. PCT/GB2022/051718, filed on Jul. 4, 2022.

(30) Foreign Application Priority Data
Jul. 13, 2021 (GB) 2110069.8

(51) Int. Cl. A47C 20/00; A47G 9/02; A47G 9/10; A47G 9/00

(52) U.S. Cl. CPC A47C 20/022; A47G 9/0253; A47G 9/1027; A47G 2009/003

(57) ABSTRACT

Patient support apparatus is known which include a bolster for supporting a person propped-up in bed to prevent that person from slipping down the bed. It is important, however, to be able to remove and/or deflate the bolster quickly if the patient needs urgent medical attention. The patient support apparatus herein comprises a sheet having a pocket, and an inflated bolster removably received therein, such that in use with the sheet arranged on the bed, the bolster is arrangeable between the person's pelvis and knees, wherein the inflated bolster includes an outer relatively low-friction sleeve for aiding the insertion and removal of the bolster into and out of the pocket, and wherein the bolster comprises a dump valve at one end thereof for rapid deflation of the bolster if necessary, the low-friction sleeve comprising a handle at one end thereof to aid removal of the bolster from the pocket.

### RELATED APPLICATIONS

This application claims the benefit under 35 U.S.C. § 120, and is a continuation, of co-pending International Application PCT/GB2022/051718, filed Jul. 4, 2022 and designating the US, which claims priority to GB Application 2110069.8, filed Jul. 13, 3021, such GB Applications also being claimed priority to under 35 U.S.C. § 119. These GB and International applications are incorporated by reference herein in their entireties.

### FIELD

The present invention relates generally to a support apparatus and finds particular, although not exclusive, utility in preventing a person lying in a hospital bed from slipping down the bed.

### BACKGROUND

Patients in hospital, for example, spend long periods confined to their bed, and they may, from time to time, wish to sit up in bed for medical reasons such as improvement in oxygenation—or for reading, eating or watching television. There is a tendency for them to slip down the bed after a while, simply due to the weight of the upper part of the body and the lack of friction between their clothes and the bedsheet over the mattress. The patient's back may be supported by pillows against a vertical or adjustable semi-vertical bedhead, and these too tend to slip so that they are no longer in the optimal position. To regain the upright or semi-upright position, the patient not only has to push himself back to the upright position, but also has to replace the pillows, which is itself an awkward action. This can be strenuous and distressing especially for weaker patients such as elderly patients. In some circumstances, nurse time is taken-up readjusting patients.

Hospital beds for use in intensive care can be arranged so that the mattress is adjustably inclined, so that the patient is at the best inclination for their medical treatment and recovery. Again, however, a patient tends to slip down the bed, until such time as the patient's centre of gravity is at the lowest position in the bed.

Similar problems arise, of course, with ordinary household beds, when the occupants wish to sit up for reading, eating or watching television, for example.

### SUMMARY

Some beds have been devised so as to avoid such problems by having different sections of the mattress each of which can have their angle of inclination adjusted. However, these are complex and expensive, and their success in preventing slipping has been limited. Accordingly, the purpose of the present invention is to provide a simple alternative, capable of widespread use.

In a first aspect, the invention provides a support apparatus for use in supporting a person propped-up in bed to prevent that person from slipping down the bed, comprising a sheet having a pocket, and an inflated bolster removably received therein, such that in use with the sheet arranged on the bed, the bolster is arrangeable between the person's pelvis and knees, wherein the inflated bolster includes an outer relatively low-friction sleeve for aiding the insertion and removal of the bolster into and out of the pocket, and wherein the bolster comprises a dump valve at one end thereof for rapid deflation of the bolster if necessary, the low-friction sleeve comprising a handle at one end thereof to aid removal of the bolster from the pocket.

In use, if an emergency requires the patient to be laid flat, such as for treating a sudden cardiac arrest, the dump valve may be opened to deflate the bolster. Alternatively, or additionally, the bolster may be quickly removed from the pocket.

The low friction sleeve not only eases the insertion and withdrawal of the bolster into and out of the pocket, but it will also reduce pressure sores due to the bolster being able to move more easily relative to the pocket, and thus the patient.

The bolster may be elongate and typically, but not exclusively, cylindrical, or have a semi-circular longitudinal cross-section; however, other shapes are contemplated. When inflated, the bolster may take the form of a relatively rigid object, such that in use, the person may lie with their thighs resting over the bolster so that the bolster provides a horizontal reaction force, preventing them from slipping down the bed.

The dump valve may include an orifice having a relatively large diameter (for example 50 mm). The sheet may comprise cotton, polyester, low friction material, and other materials typically used for bedding.

The sheet may comprise a mattress pocket at one end thereof for fitting over the mattress at the head-end of the bed. The term “mattress pocket” may include the tailored head-end of a ‘fitted-sheet’ style sheet.

The sheet may have a length such that it only extends approximately half-way along the length of a standard adult size bed. The sheet may comprise tightening means for pulling its sides towards one another underneath the mattress to thereby reduce the risk of the sheet and bolster moving down the bed in use.

The tightening means may comprise a strap or cord. The tightening means may comprise eyelets in the sheet. In this way, a cord may be used to lace the sides together.

The bolster may be arranged in two inflatable parts leaving a gap therebetween approximately at the centre, width-wise, of the bed. This may decrease pressure on certain parts of the patient's body, especially for males.

The longitudinal cross-section of the pocket may be cylindrical, or semi-circular; however, other shapes are contemplated. The pocket may be open at either or both ends. The bolster may be long enough to extend substantially the full width of a single bed.

The support apparatus may include an integral air pump for inflating the bolster. The support apparatus may include two handles on the low friction sleeve, one arranged at either end of the bolster. The bolster may include a dump valve at either end of the bolster. The bolster may include two outer, concentric, relatively low-friction sleeves for aiding the insertion and removal of the bolster into and out of the pocket.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a schematic perspective view of part of a mattress and a sheet including a support apparatus;

FIG. 2 is a perspective view of a bolster;

FIG. 3 is a schematic side view of the bed of FIG. 1 in use;

FIG. 4 is a schematic side view of the bed of FIG. 1 in an alternative arrangement; and

FIG. 5 is a schematic underside view of a mattress including support apparatus.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

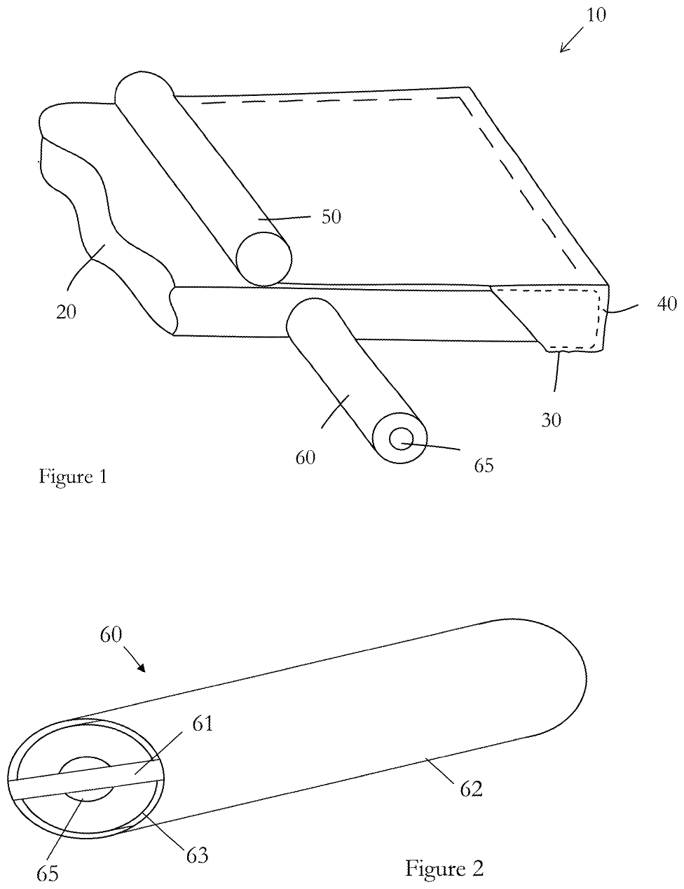

With reference to FIG. 1, a first arrangement 10 is shown comprising a portion of a mattress 20 with a bedsheet 40 arranged over the top of the mattress. The outline of the part of the mattress hidden by the bedsheet 40 is shown in broken lines. A fitted “pocket” 30 is provided at the head-end of the bedsheet to fit around the head-end of the mattress 20 to maintain the sheet in place in use. The bedsheet 40 includes a pocket 50 into which a bolster 60 may be removably insertable. The bedsheet is arranged to cover a predetermined fraction, for example one third, or one half, of the length of a standard single mattress, and to span the full width of the mattress. Although not shown, the sheet may be wide enough to be tucked under the mattress along the sides of the bed.

The bolster 60 is cylindrical in shape with a circular cross-section. It is an inflatable bladder of suitable gas-impermeable, puncture-resistant fabric. A dump valve 65 is provided at one end thereof for inflating the bolster under normal lung pressure, and for allowing it to be deflated. When deflated, the bolster can be folded or rolled and can be packed away with the bedsheet 40.

The bolster 60 is shown in more detail in FIG. 2, where the low-friction sleeve 62 is shown as close-fitting to the outer surface of the inflatable bladder 63. The low-friction sleeve 62 is shown, in this case, in the form of an open-ended cylinder. At one end a handle in the form of a strap 61 is arranged across the open end of the cylinder. Optionally, another one is arranged at the other end of the cylinder. These aid the insertion and removal of the bolster 60 from the pocket 50. The dump valve 65 is also visible at one end. Optionally, another one is arranged at the other end of the cylinder.

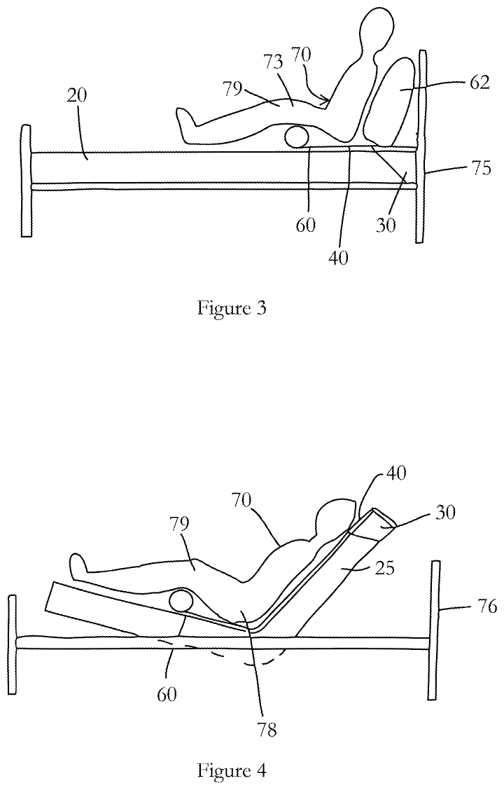

As shown in FIG. 3, the bedsheet 40 is positioned on a typically horizontal, planar mattress 20 arranged on a bed frame 75 such that, in use, with a patient 70 sitting upright with his back against a cushion or pillow 62, his thighs 73 are resting against the bolster 60. The bolster is arranged between the patient's pelvis 78 and knees 79. Preferably, it is located at the top of the patient's thighs. The bolster 60 exerts a reaction force on the patient's thighs 73 and pelvis 78, preventing him from sliding down the bed.

In FIG. 4, the mattress 25 has been bent into an approximate “L” shape such that the head-end is raised relative to the foot-end, and the foot-end is raised slightly, relatively to the frame 76. A bolster 60 is provided on a bedsheet 40 and is arranged between the patient's 70 pelvis 78 and knees 79 to thereby prevent the patient from slipping down the bed.

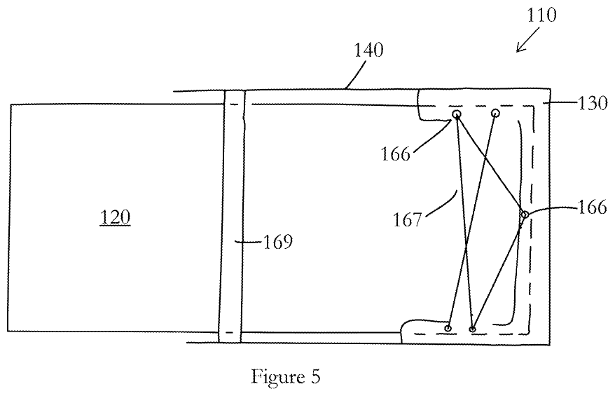

An alternative, or additional arrangement 110 for securing the bedsheet to a mattress is shown in FIG. 5 which shows the underside of a mattress 120. The bedsheet 140 includes a pocket 130 at the head-end to secure it to the mattress and prevent movement thereof towards the foot-end. However, this pocket 130 is optional in this case because eyelets 166 are provided on the sides of the bedsheet towards the head-end when fitted, and at the head-end, when fitted. A cord 167 is laced through the various eyelets 166 and tightened to help retain the bedsheet 140 in place on the bed and prevent movement relative thereto. The outline of the part of the mattress hidden by the bedsheet 140 is shown in broken lines.

A strap 169 is also shown extending width-wise across, and under, the mattress. This strap is attached to the bedsheet 140 further towards the foot-end of the mattress and further aids retention of the bedsheet 140 and thus the bolster 55 in place. This strap 169 is optional.

1. A support apparatus for use in supporting a person propped-up in bed to prevent that person from slipping down the bed, comprising a sheet having a pocket, and an inflated bolster removably received therein, such that in use with the sheet arranged on the bed, the bolster is arrangeable between the person's pelvis and knees, wherein the inflated bolster includes an outer relatively low-friction sleeve for aiding the insertion and removal of the bolster into and out of the pocket, and wherein the bolster comprises a dump valve at one end thereof for rapid deflation of the bolster if necessary, the low-friction sleeve comprising a handle at one end thereof to aid removal of the bolster from the pocket.

2. The support apparatus of claim 1, wherein the sheet comprises a mattress pocket at one end thereof for fitting over the mattress at the head-end of the bed.

3. The support apparatus of claim 1, wherein the sheet has a length such that it only extends approximately half-way along the length of a standard adult size bed.

4. The support apparatus of claim 1, wherein the sheet comprises tightening means for pulling its sides towards one another underneath the mattress to thereby reduce the risk of the sheet and bolster moving down the bed in use.

5. The support apparatus of claim 4, wherein the tightening means comprise a strap or cord.

6. The support apparatus of claim 4, wherein the tightening means comprises eyelets in the sheet.

7. The support apparatus of claim 1, wherein the bolster is arranged in two inflatable parts leaving a gap therebetween approximately at the centre, width-wise, of the bed.

8. The support apparatus of claim 1, including an integral air pump for inflating the bolster.

9. The support apparatus of claim 1, including two handles on the low friction sleeve, one arranged at either end of the bolster.

10. The support apparatus of claim 1, including a dump valve at either end of the bolster.

11. The support apparatus of claim 1, including two outer relatively low-friction sleeves for aiding the insertion and removal of the bolster into and out of the pocket.
